(19) United States
(12) Patent Application Publication
(10) Pub. No.: US 2019/0256395 A1
(43) Pub. Date: Aug. 22, 2019

(54) Silicate Aggregate Manufacturing System

(71) Applicant: Good Planet Labs, Inc., Las Vegas, NV (US)

(72) Inventor: Robert Michael Hust, Coeur d'Alene, ID (US)

(21) Appl. No.: 16/277,517

(22) Filed: Feb. 15, 2019

Related U.S. Application Data
(60) Provisional application No. 62/631,570, filed on Feb. 16, 2018.

(51) Int. Cl. C03B 5/235; C03B 3/02; C03B 35/18; C03B 35/06

(52) U.S. Cl. CPC C03B 5/235; C03B 35/062; C03B 35/18; C03B 3/02

(57) ABSTRACT

Systems and methods for generation of porous silicate aggregates are disclosed. For example, the manufacturing systems may include a conveyor element, multiple hoppers positioned over a first section of the conveyor element, one or more derricks and/or holding elements to move and/or hold the hoppers, a kiln positioned with respect to a second portion of the conveyor element, and/or computing components to allow for control of the components of the system. The system may produce single-layer products in a continuous fashion, multi-layered products having multiple physical and/or chemical properties, and/or more than one product at a time.

### RELATED APPLICATIONS

This application claims priority to U.S. Provisional Patent Application No. 62/631,570, filed on Feb. 16, 2018, the entire contents of which are incorporated herein by reference.

### BACKGROUND

The production of glass and/or ceramic aggregates may be beneficial in multiple use cases. The production of such materials may include the use of a kiln where precursor materials are added and a finalized glass and/or ceramic product is produced. Described herein are improvements and technological advances that, among other things, improve the manufacture of glass and/or ceramic aggregates.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the components on a larger scale or differently shaped for the sake of clarity.

FIG. 1 illustrates a side view of an example system for generating silicate aggregates.

FIG. 2 illustrates a side view of another example system for generating silicate aggregates.

FIG. 3 illustrates a side view of another example system for generating silicate aggregates.

FIG. 4 illustrates a cross-sectional view, taken at a midpoint of a hopper of another silicate aggregate manufacturing system, of the hopper.

FIG. 5 illustrates a top view of the example system for generating silicate aggregates from FIG. 2.

FIG. 6 illustrates a side view of a portion of an example system for generating silicate aggregates showing three hoppers each outputting a different precursor material.

FIG. 7 illustrates a side view of a portion of another example system for generating silicate aggregates showing three hoppers, with one of the hoppers output a separation-layer material.

FIG. 8 is a flowchart illustrating an example process of manufacturing silicate aggregates utilizing the systems described herein.

### DETAILED DESCRIPTION

Systems and methods for generating silicate aggregates are disclosed. Take, for example, situations where silicate aggregates are to be made. Silicate aggregates, otherwise described herein as foam glass and/or ceramic aggregates, may be utilized for a number of purposes, such as insulation, remediation of waste, filler material, a component of concrete or other hardscape, and/or one or more other uses. Generally, silicate aggregates may be composed of a precursor material such as a glass-grade silica powder, ground glass, silica-lime glass, and/or calcium-carbonate lime, for example. However, conventional silicate aggregates have a single composition, have homogenous and/or uniform properties, have a single density, have a single porosity, and/or are either open-celled or close-celled.

Described herein are systems and methods of producing novel silicate aggregates that, among other things, may have multiple layers with differing physical properties, may have varying porosities, may have varying densities, and/or may be both close-celled and open-celled at different portions of the silicate aggregates, for example. The systems may include, for example, a conveyor element such as a conveyor belt configured to move precursor materials into a kiln and move produced silicate aggregate from the kiln to a holding container. The conveyor element may be configured to vary the speed at which the conveyor element moves precursor materials. The system may also include, two or more hoppers that may be configured to hold precursor materials. The hoppers may be positioned at a point before the kiln such that as materials exit the hoppers and land on the conveyor element, the conveyor element may convey the materials into the kiln. The hoppers may be substantially adjacent to each other and may each have an opening on an end of the hoppers proximal to the conveyor element. The opening may allow the precursor materials to flow from the hoppers onto the conveyor element. The opening may be adjustable such that more or less precursor material is allowed to flow from the hoppers to the conveyor element. The hoppers may also include a wheel housed within the hopper and configured to rotate to promote the flow of precursor material within the hopper and through the opening. The wheel may be configured to turn at various, adjustable speeds to increase or decrease the flow of precursor material from the hopper to the conveyor element. It should be understood that a roller and/or drum may be utilized instead of a wheel.

The systems may additionally, in examples, include one or more derricks and/or similar mechanisms. The derricks may be attached, either fixedly or removeably, to the hoppers and may be configured to move the hoppers from a position above the conveyor element to a position that allows for filling of the hoppers with precursor materials. In examples, each hopper is associated with its own derrick. In other examples, the one or more derricks may include a grasping element that may be configured to grasp at least a portion of a hopper to move it between different locations. In these examples where the derricks are not fixedly attached to the hoppers, the systems may include one or more hopper holders, also descried herein as hopper receptacles, that may be configured to receive the hoppers as placed by the derrick(s). The same derrick may release a given hopper and grab another hopper, as desired. In other examples, the system may not include a derrick but instead may include a hopper-holding element configured to fixedly hold two or more hoppers above the conveyor element. In these examples, the system may include a filling element, such as a pneumatic system, configured to transfer precursor material from a storage container to the two or more hoppers.

The systems may additionally include one or more kilns. The kiln may be configured to allow a portion of the conveyor element to pass through at least a portion of the kiln such that the precursor materials may enter an interior portion of the kiln, and silicate aggregate product may exit the kiln. For example, the kiln may have a channel configured to receive a portion of the conveyor element, with a first end of the kiln configured to receive the precursor materials via the conveyor element and a second end of the kiln, opposite the first end, configured to output a product from the kiln. The kiln may be configured to apply heat to the precursor material as it travels through the kiln. In examples, the amount of heat applied by the kiln to the precursor materials may be adjustable. For example, the temperature inside the kiln may be set to between about 900° Fahrenheit and about 1,600° Fahrenheit. In further examples, the kiln may be configured to apply a heating gradient and/or differing temperatures to the precursor materials as they travel through the kiln. For example, a temperature of the kiln may be adjusted to be the highest about ⅓ of the way through the kiln such that the precursor materials may reach a working point and/or working temperature. Thereafter, the temperature may vary depending on, for example, the speed at which the conveyor element is moving and/or specifications for the silicate aggregate product desired as output from the kiln. In examples, the time between when the precursor materials enter the kiln and when a silicate aggregate product exits the kiln may be between about 40 minutes and about 75 minutes.

The systems may also include one or more computing components that may be utilized to control the operation of the various components of the systems. For example, the computing components may include one or more processors, one or more network interfaces, and/or memory storing instructions that, when executed, cause the one or more processors to perform operations associated with the manufacture of silicate aggregates. For example, the operations may include controlling the speed at which the conveyor element moves, the volume of precursor material that exits one or more of the hoppers, a time at which the hoppers are moved by the derricks for filling of precursor materials and/or for placement above the conveyor element, an amount of precursor material added to the hoppers, a time at which the hoppers start and/or stop allowing precursor materials to travel from the hoppers to the conveyor element, a temperature and/or temperature gradient at which to set the kiln, and/or when to enable and/or disable one or more components of the systems. The computing components may include one or more input mechanisms such as a keyboard, mouse, touchscreen, etc. to allow a user of the system to physically provide input to the computing components to control the silicate aggregate manufacturing systems.

Additionally, or alternatively, the one or more network interfaces may be configured to receive data from one or more other devices, such as mobile devices and/or remote servers and/or remote systems. In these examples, the received data may cause the systems to perform one or more of the operations described above such that a user need not be physically present at the systems to operate them. Additionally, the network interfaces may be utilized to send data associated with the operations of the systems to the one or more other devices. By so doing, one or more remote operators and/or users may be enabled to observe operation of the systems without necessarily being physically present at the systems. In these examples, the systems may include one or more sensors that may generate data indicating operational parameters of the systems. For example, one or more temperature sensors, pressure sensors, motion sensors, and/or weight and/or volume sensors may be included in the systems.

Additionally, or alternatively, the hoppers of the systems may be configured to release precursor materials in one of various ways. For example, in a first instance where a given system includes two hoppers, the two hoppers may be configured to release precursor materials at substantially the same time such that a first hopper transfers a first layer of precursor material onto the conveyor element. A second hopper positioned between the first hopper and the kiln may be configured to transfer a second layer of the precursor material or another precursor material onto the conveyor element. While two hoppers are described in this example as transferring two layers of precursor materials, it should be understood that the system may have two or more than two hoppers, and those hoppers may transfer two or more than two layers of precursor materials. In these examples, the thickness of each of the several layers may be controllable, such as by controlling the amount of precursor material exiting a given hopper per unit time.

In a second instance, the two hoppers of a given system may be configured to release precursor materials sequentially. For example, a first hopper may release precursor materials and when the precursor materials in the first hopper have been exhausted or otherwise have been transferred to the conveyor element, a second hopper may initiate release of precursor materials. In this example, a continuous or near continuous flow of precursor materials may occur such that when one hopper empties or nearly empties another hopper initiates release of precursor materials. While the second hopper releases precursor materials, the first hopper may be refilled such that when the second hopper empties, the first hopper may be caused to release precursor materials, and so on. By so doing, the conveyor may not require stoppage for refilling of precursor materials, the kiln may not require stoppage for refilling of precursor materials, and/or no or less interruption in the flow of precursor materials into the kiln may be achieved.

In a third instance, a given system may have three or more hoppers. In this example, a first hopper may be configured to transfer a base layer of precursor materials onto the conveyor element. A second hopper positioned between the first hopper and the kiln may be configured to transfer a separation-layer of materials on top of the base layer. A third hopper positioned between the second hopper and the kiln may be configured to transfer additional and/or different precursor materials on top of the separation-layer of materials. In these examples, while being heated in the kiln, the top layer and base layer of precursor materials may be converted to silicate aggregates, while the separation layer may prohibit or decrease the binding of the top layer to the base layer. As such, the top layer may be separated from the base layer after manufacture of the silicate aggregates such that two products may be obtained during the same run time for the kiln.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details of these and other examples are described below with reference to the drawings.

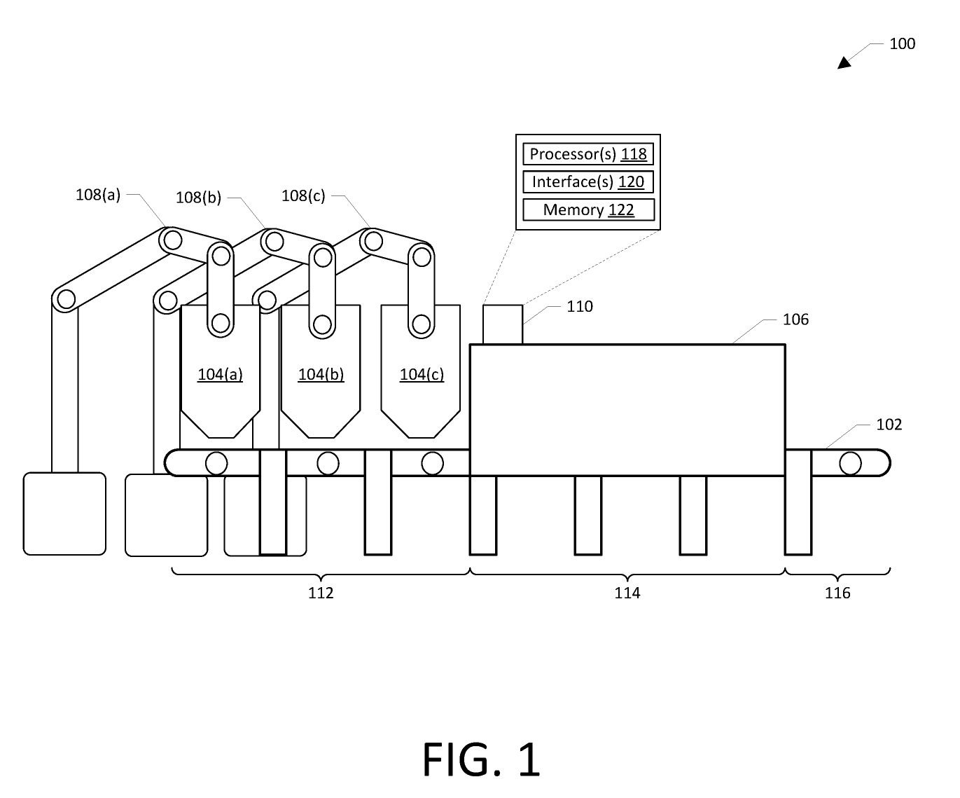

FIG. 1 depicts a side view of an example system 100 for generating silicate aggregates. The system 100 may include, for example, a conveyor element 102, two or more hoppers 104(a)-(c), a kiln 106, one or more derricks 108(a)-(c), and computing components 110. Each of these components will be described below by way of example.

The conveyor element 102, which may be a conveyor belt, may be configured to move precursor materials into the kiln 106 and move produced silicate aggregate from the kiln 106 to a holding container (not depicted). The conveyor element 102 may be configured to vary the speed at which the conveyor element 102 moves precursor materials. For example, the speed of movement of the conveyor element 102 may be adjustable such that an amount of time from when the precursor material(s) enter the kiln 106 and when the produced silicate aggregates exit the kiln 106 may be varied. In examples, the amount of time may be between about 40 minutes and about 75 minutes. Additionally, the conveyor element 102 may include a first section 112, a second section 114, and a third section 116. In examples, the first section 112 may include at least the portion of the conveyor element 102 that is positioned below the two or more hoppers 104(a)-(c). The second section 114 may include at least the portion of the conveyor element 102 that is associated with and/or is held within the kiln 106. The third section 116 may include at least the portion of the conveyor element 102 after the kiln 106 and that carries, when in use, produced silicate aggregate from the kiln 106.

The two or more hoppers 104(a)-(c) may be configured to hold precursor materials. The hoppers 104(a)-(c) may be positioned at a point before the kiln 106, such that as materials exit the hoppers 104(a)-(c) and are transferred to the conveyor element 102, the conveyor element 102 may convey the materials into the kiln 106. The hoppers 104(a)-(c) may be substantially adjacent to each other and each hopper 104(a)-(c) may have an opening on an end of the hoppers 104(a)-(c) proximal to the conveyor element 102. The opening may allow the precursor materials to flow from the hoppers 104(a)-(c) onto the conveyor element 102. The opening may be adjustable such that more or less precursor material is allowed to flow from the hoppers 104(a)-(c) to the conveyor element 102. The hoppers 104(a)-(c) may also include a wheel housed within the hoppers and configured to rotate to promote the flow of precursor material within the hoppers 104(a)-(c) and through the opening. The wheel may be configured to turn at various, adjustable speeds to increase or decrease the flow of precursor material from the hoppers 104(a)-(c) to the conveyor element 102. It should be understood that a roller and/or drum may be utilized instead of or in addition to a wheel.

It should be understood that while three hoppers 104(a)-(c) are depicted with respect to FIG. 1, the system 100 may include two, three, or more than three hoppers. Additionally, while one or more examples described herein discuss the hoppers generally holding precursor material, it should be understood that the hoppers may all hold the same precursor material or one or more of the hoppers may hold a precursor material that differs in one or more respects from precursor material held by another of the hoppers. For example, a precursor material may include a glass-grade silica powder, ground glass, and/or silica-lime glass, for example. The precursor materials may also include one or more foaming agents. The types of precursor materials and/or the quantities of precursor materials, both within a given hopper and/or as between hoppers, may vary from hopper to hopper.

The one or more derricks 108(a)-(c) and/or similar mechanisms may be attached, either fixedly or removeably, to the hoppers 104(a)-(c) and may be configured to move the hoppers 104(a)-(c) from a position above the conveyor element 102 to a position that allows for filling of the hoppers 104(a)-(c) with precursor materials. In examples, each hopper 104(a)-(c) is associated with its own derrick 106(a)-(c). For example, a first hopper 104(a) may be associated with a first derrick 108(a); a second hopper 104(b) may be associated with a second derrick 108(b); and a third hopper 104(c) may be associated with a third derrick 104(c), all as depicted in FIG. 1. As used herein, a derrick may describe a type of crane with a movable pivoted arm for moving and/or lifting heavy objects, such as hoppers 104(a)-(c). It should be understood that the derricks may also be described as a hoist, lift, lifting machining, moving machine, and/or rig.

The kiln 106 may be configured to allow a portion of the conveyor element 102 to pass through at least a portion of the kiln 106 such that the precursor materials may enter an interior portion of the kiln 106, and silicate aggregate product may exit the kiln 106. For example, the kiln 106 may have a channel configured to receive a portion of the conveyor element, with a first end of the kiln 106 configured to receive the precursor materials via the conveyor element 102 and a second end of the kiln 106, opposite the first end, configured to output a product from the kiln 106. In examples, the kiln 106 may be positioned relative to the second section 114 of the conveyor element 102. The kiln 106 may be configured to apply heat to the precursor material as it travels through the kiln 106. In examples, the amount of heat applied by the kiln 106 to the precursor materials may be adjustable. For example, the temperature inside the kiln 106 may be between about 900° Fahrenheit and about 1,600° Fahrenheit. In further examples, the kiln 106 may be configured to apply a heating gradient and/or differing temperatures to the precursor materials as they travel through the kiln 106. For example, a temperature of the kiln 106 may be adjusted to be the highest about ⅓ of the way through the kiln 106 such that the precursor materials may reach a working point and/or working temperature at that point in the kiln 106. Thereafter, the temperature may vary depending on, for example, the speed at which the conveyor element 102 is moving and/or specifications for the silicate aggregate product desired as output from the kiln 106. In examples, the time between when the precursor materials enter the kiln 106 and when a silicate aggregate product exits the kiln 106 may be between about 40 minutes and about 75 minutes.

In examples, one or more mechanical and/or tactile means of controlling the components of the system 100 and/or measuring certain precursor materials and/or products may be utilized. For example, one or more buttons, switches, levers, wheels, shutters, and/or other mechanical mechanisms may be utilized to control the speed at which the conveyor element 102 moves, the volume of precursor material that exits one or more of the hoppers 104(a)-(c), a time at which the hoppers 104(a)-(c) are moved by the derricks 108(a)-(c) for filling of precursor materials and/or for placement above the conveyor element 102, an amount of precursor material added to the hoppers 104(a)-(c), a time at which the hoppers 104(a)-(c) start and/or stop allowing precursor materials to travel from the hoppers 104(a)-(c) to the conveyor element 102, a temperature and/or temperature gradient at which to set the kiln 106, and/or when to enable and/or disable one or more components of the system 100.

The one or more computing components 110 may be utilized to control the operation of the various components of the system 100. For example, the computing components 110 may include one or more processors 118, one or more network interfaces 120, and/or memory 122 storing instructions that, when executed, cause the one or more processors 118 to perform operations associated with the manufacture of silicate aggregates. For example, the operations may include controlling the speed at which the conveyor element 102 moves, the volume of precursor material that exits one or more of the hoppers 104(a)-(c), a time at which the hoppers 104(a)-(c) are moved by the derricks 108(a)-(c) for filling of precursor materials and/or for placement above the conveyor element 102, an amount of precursor material added to the hoppers 104(a)-(c), a time at which the hoppers 104(a)-(c) start and/or stop allowing precursor materials to travel from the hoppers 104(a)-(c) to the conveyor element 102, a temperature and/or temperature gradient at which to set the kiln 106, and/or when to enable and/or disable one or more components of the system 100. The computing components 110 may include one or more input mechanisms such as a keyboard, mouse, touchscreen, etc. to allow a user of the system to physically provide input to the computing components 110 to control the silicate aggregate manufacturing systems.

Additionally, or alternatively, the one or more network interfaces 120 may be configured to receive data from one or more other devices, such as mobile devices and/or remote servers and/or remote systems. In these examples, the received data may cause the system 100 to perform one or more of the operations described above such that a user need not be physically present at the system 100 to operate it. Additionally, the network interfaces 120 may be utilized to send data associated with the operations of the system 100 to the one or more other devices. By so doing, one or more remote operators and/or users may be enabled to observe operation of the system 100 without necessarily being physically present at the system 100. In these examples, the system 100 may include one or more sensors that may generate data indicating operational parameters of the system 100. For example, one or more temperature sensors, pressure sensors, motion sensors, and/or weight and/or volume sensors may be included in the system.

As used herein, a processor, such as processor 118, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 118 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 118 may possess its own local memory, which also may store program components, program data, and/or one or more operating systems.

The memory 122 may include volatile and nonvolatile memory, removable and non-removable media implemented in any method or technology for storage of information, such as computer-readable instructions, data structures, program component, or other data. Such memory 122 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 122 may be implemented as computer-readable storage media (“CRSM”), which may be any available physical media accessible by the processor(s) 118 to execute instructions stored on the memory 122. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 122, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 120 may enable messages between the components and/or devices shown in system 100 and/or with one or more other remote systems, as well as other networked devices. Such network interface(s) 120 may include one or more network interface controllers (NICs) or other types of transceiver devices to send and receive messages over a network.

For instance, each of the network interface(s) 120 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 120 may include a wide area network (WAN) component to enable message over a wide area network.

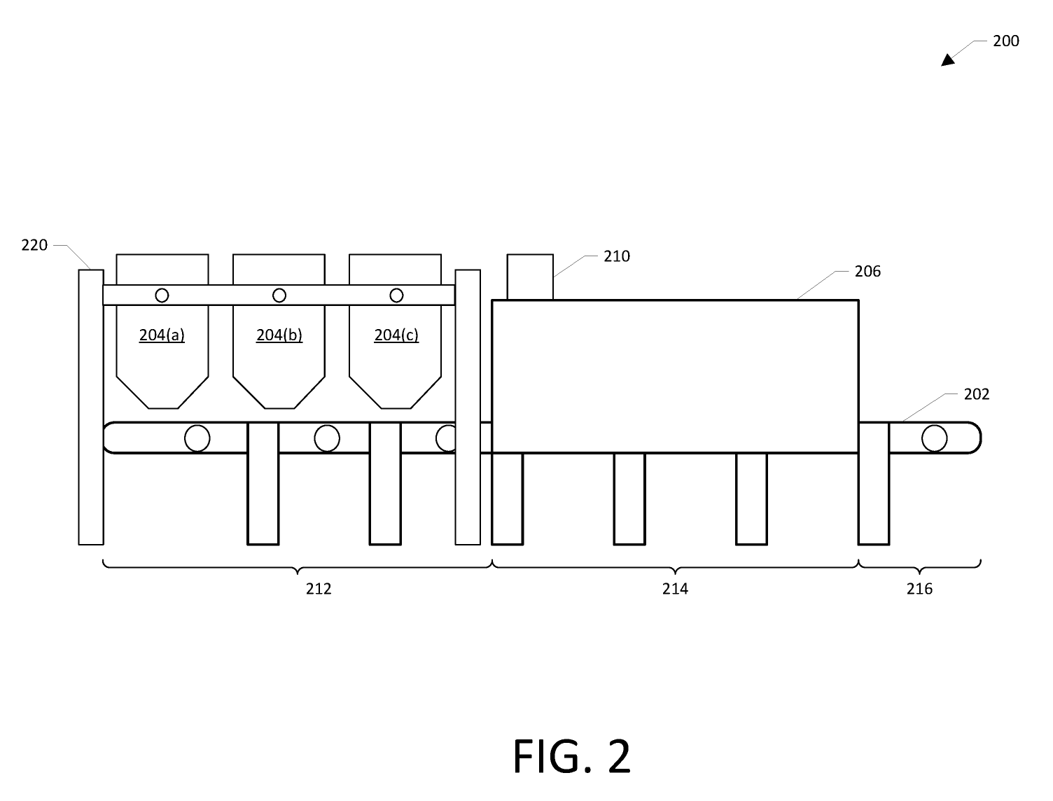

FIG. 2 illustrates a side view of another example system 200 for generating silicate aggregates. The system 200 may include, for example, a conveyor element 202, two or more hoppers 204(a)-(c), a kiln 206, and computing components 210. In examples, the conveyor element 202 may include the same or similar components and may operate in the same or a similar manner as the conveyor element 102 described with respect to FIG. 1. The conveyor element 202 may include a first section 212, a second section 214, and a third section 216 that may function in the same or a similar manner as the first section 112, the second section 114, and the third section 116, respectively, from FIG. 1. Additionally, the hoppers 204(a)-(c) may include the same or similar components and may operate in the same or a similar manner as the hoppers 104(a)-(c) described with respect to FIG. 1. Additionally, the kiln 206 may include the same or similar components and may operate in the same or a similar manner as the kiln 106 described with respect to FIG. 1. Additionally, the computing component 210 may include the same or similar components and may operate in the same or a similar manner as the computing components 110 described with respect to FIG. 1.

Additionally, the system 200 may not include a derrick as described with respect to FIG. 1, but instead may include a hopper-holding element 220 configured to fixedly hold one or more of the hoppers 204(a)-(c) above the conveyor element 202. In these examples, the system 200 may include a filling element configured to transfer precursor material from a storage container to the two or more hoppers 204(a)-(c). The hopper-holding element 220 may include one or more holes and/or slots that may be sized to receive at least a portion of a given hopper 204(a)-(c). Additionally, in examples, the hoppers 204(a)-(c) may be fixedly and/or removeably attached to the hopper-holding element 220 such that the hoppers 204(a)-(c) may be stationary and disposed above the conveyor element 202 while the system 200 is in use.

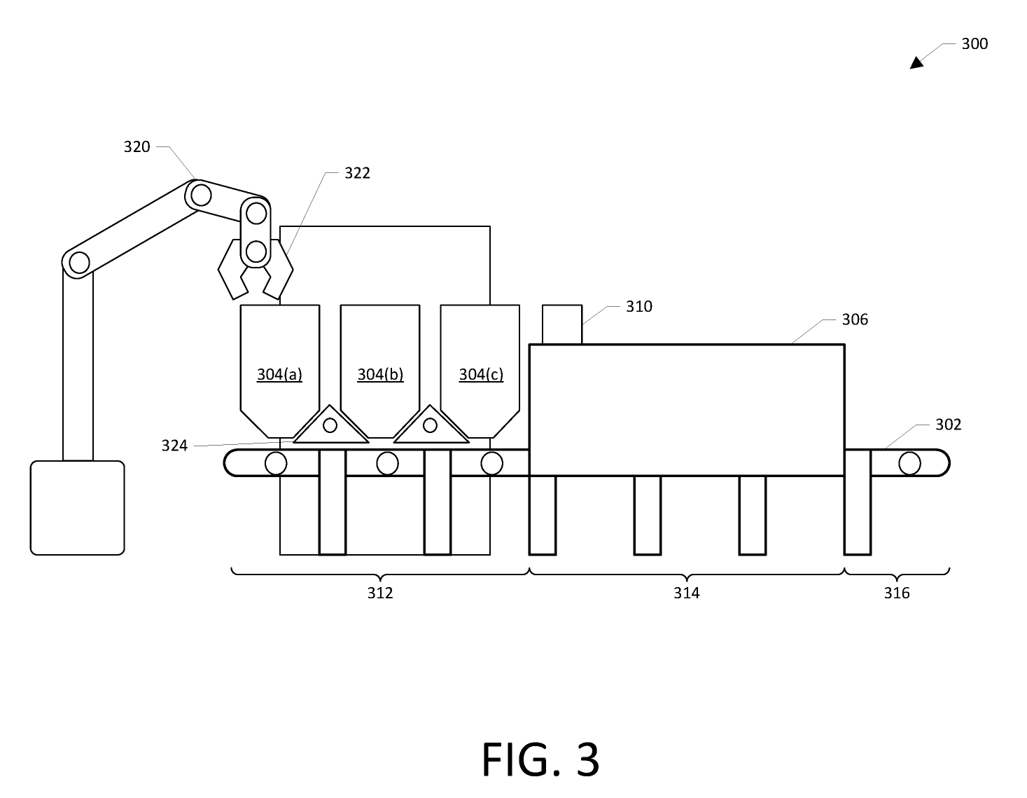

FIG. 3 illustrates a side view of another example system 300 for generating silicate aggregates. The system 300 may include, for example, a conveyor element 302, two or more hoppers 304(a)-(c), a kiln 306, and computing components 310. In examples, the conveyor element 302 may include the same or similar components and may operate in the same or a similar manner as the conveyor element 102 described with respect to FIG. 1. The conveyor element 302 may include a first section 312, a second section 314, and a third section 316 that may function in the same or a similar manner as the first section 112, the second section 114, and the third section 116, respectively, from FIG. 1. Additionally, the hoppers 304(a)-(c) may include the same or similar components and may operate in the same or a similar manner as the hoppers 104(a)-(c) described with respect to FIG. 1. Additionally, the kiln 306 may include the same or similar components and may operate in the same or a similar manner as the kiln 106 described with respect to FIG. 1. Additionally, the computing component 310 may include the same or similar components and may operate in the same or a similar manner as the computing components 110 described with respect to FIG. 1.

Additionally, the system 300 may include one or more derricks 320. The derricks 320 may include a grasping element 322 that may be configured to grasp at least a portion of a hopper 304(a)-(c) to move them between different locations. In these examples where the derricks 320 are not fixedly attached to the hoppers 304(a)-(c), the system 300 may include one or more hopper holders 324 that may be configured to receive the hoppers 304(a)-(c) as placed by the derrick 320. The same derrick 320 may release a given hopper 304(a)-(c) and grab another hopper 304(a)-(c), as desired.

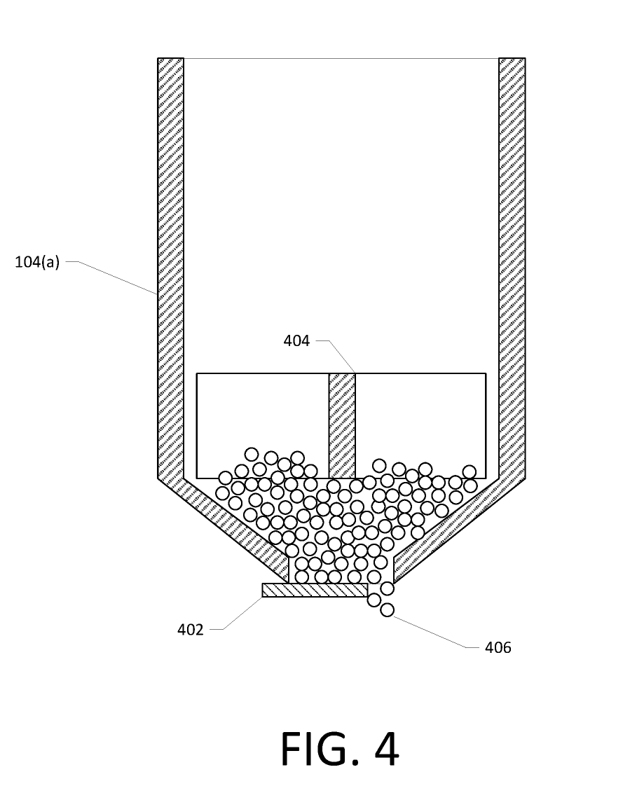

FIG. 4 illustrates a cross-sectional view, taken at a midpoint of a hopper 104(a) of a silicate aggregate manufacturing system, of the hopper 104(a). The hopper 104(a) may be configured to hold precursor materials 406. The hopper 104(a) may have an opening on an end of the hopper 104(a) proximal to the conveyor element. The opening may allow the precursor materials 406 to flow from the hopper 104(a) onto the conveyor element. The opening may be adjustable such that more or less precursor material 406 is allowed to flow from the hopper 104(a) to the conveyor element. For example, a shutter 402 or similar mechanism may be adjustable such that the size of the opening of the hopper 104(a) may be increased or decreased. The shutter 402 may be adjusted through tactile input and/or the shutter 402 may include one or more electronic components that may receive a signal and/or data and cause the shutter 402 to move to open and/or close the opening.

The hopper 104(a) may also include a wheel 404 housed within the hopper 104(a) and configured to rotate to promote the flow of precursor material 406 within the hopper 104(a) and through the opening. A roller and/or drum may be utilized instead of or in addition to the wheel 404. The wheel 404 may be configured to turn at various, adjustable speeds to increase or decrease the flow of precursor material 406 from the hopper 104(a) to the conveyor element. For example, when the wheel 404 is caused to rotate more quickly, the flow of precursor material 406 may also increase. When the wheel 404 is caused to rotate less quickly, the flow of precursor material 406 may also decrease. The speed of the wheel 404 may be adjusted through tactile input and/or the wheel 404 may include and/or be associated with one or more electronic components that may receive a signal and/or data and cause the wheel 404 to move at a given rate and/or speed. It should be understood that while a wheel is described herein as a mechanism to improve the flow of precursor materials within the hopper, this disclosure specifically includes one or more other mechanisms to promote precursor flow. These mechanisms may include one or more arms, appendages, pneumatic methods, stirring mechanisms, and the like.

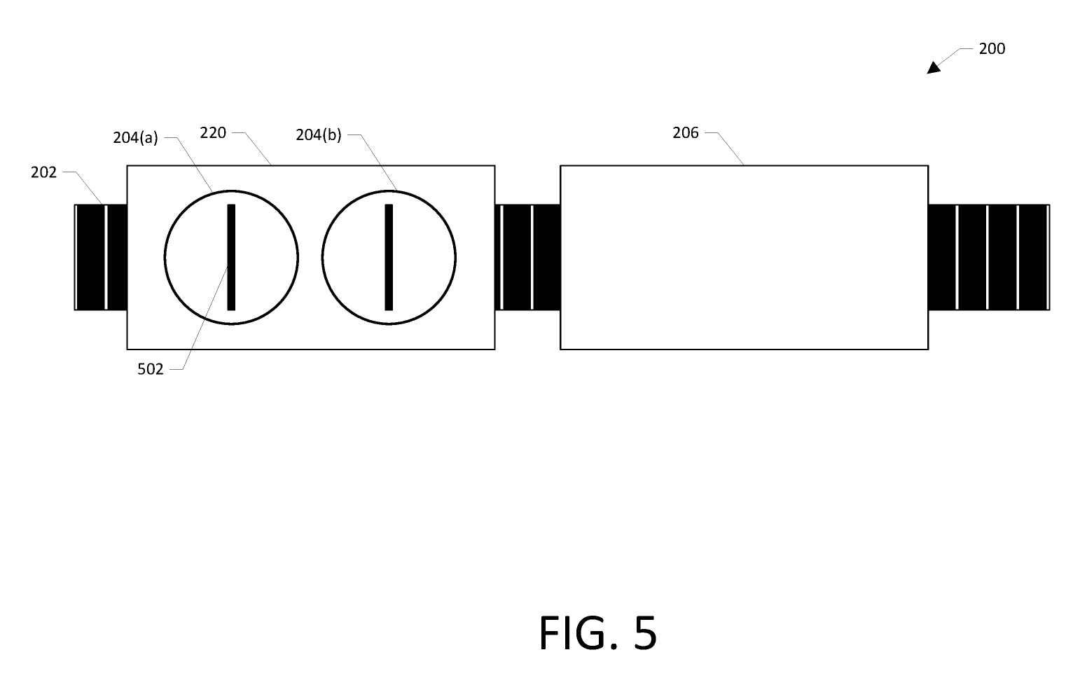

FIG. 5 illustrates a top view of the example system 200 for generating silicate aggregates from FIG. 2. The system 200 may include, for example, a conveyor element 202, two or more hoppers 204(a)-(b), a kiln 206, and a hopper-holding element 220. In examples, the conveyor element 202 may include the same or similar components and may operate in the same or a similar manner as the conveyor element 102 described with respect to FIG. 1. Additionally, the hoppers 204(a)-(b) may include the same or similar components and may operate in the same or a similar manner as the hoppers 104(a)-(c) described with respect to FIG. 1. Additionally, the kiln 206 may include the same or similar components and may operate in the same or a similar manner as the kiln 106 described with respect to FIG. 1.

The hoppers 104(a)-(b) may be substantially adjacent to each other and each hopper 104(a)-(b) may have an opening 502, otherwise described herein as a nozzle, on an end of the hoppers 104(a)-(b) proximal to the conveyor element 202. The opening 502 may allow the precursor materials to flow from the hoppers 104(a)-(b) onto the conveyor element 202. The opening 502 may be adjustable such that more or less precursor material is allowed to flow from the hoppers 104(a)-(b) to the conveyor element 202. As shown in FIG. 5, the opening 502 may be sized such that a first dimension of the opening 502 is substantially smaller than a second dimension. For example, a width of the opening 502 may be sized to be similar to a width of the conveyor element 202, such that, as precursor material exits the hopper 104(a)-(b), the precursor material is deposited on all or nearly all of the width of the conveyor element 202. A length of the opening 502 may be substantially smaller than the width, such as, for example, from about 0.1 inches to about 2 inches. As discussed above, the width and/or length of the opening 502 may be adjusted to be smaller or larger depending on desired application.

In the example of FIG. 5 with two hoppers 104(a)-(b), the opening 502 for each hopper 104(a)-(b) may be the same or approximately the same. In other examples, the opening 502 for one hopper 104(a) may be smaller or larger than the opening 502 for another hopping 104(b). By so doing, the system 200 may allow for a user to generate layers of precursor materials where one layer is thicker than another layer or where the multiple layers have approximately the same thickness.

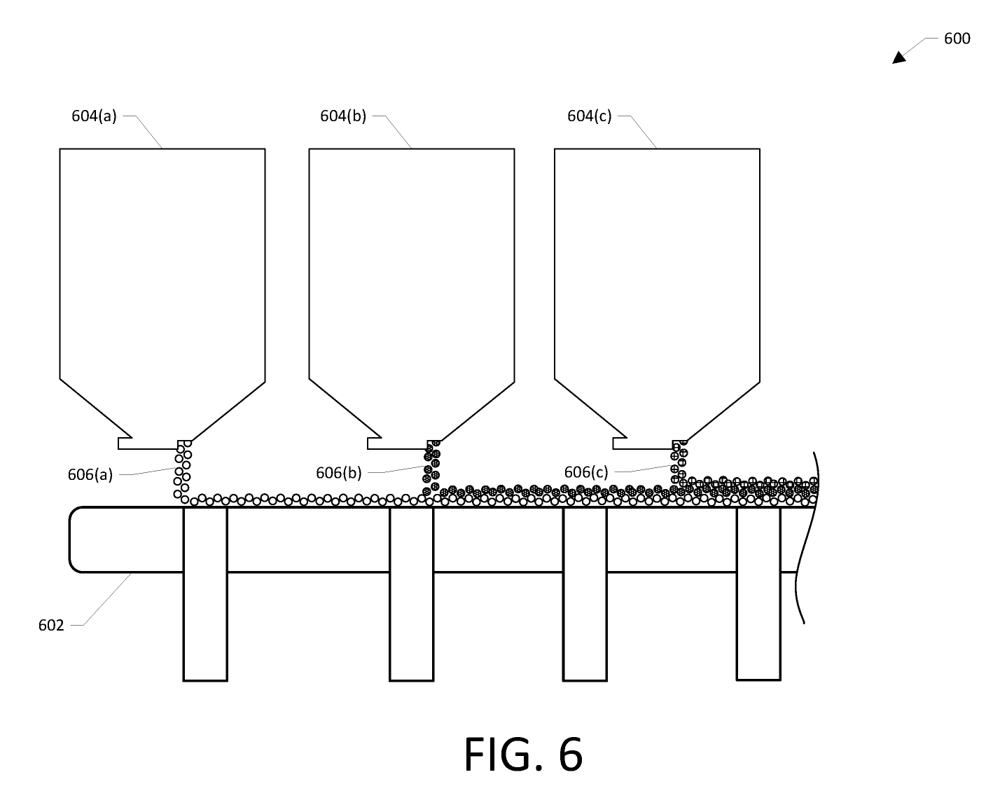

FIG. 6 illustrates a side view of a portion of an example system 600 for generating silicate aggregates showing three hoppers 604(a)-(c) each outputting a different precursor material 606(a)-(c). The system 600 may include, for example, a conveyor element 602, two or more hoppers 604(a)-(c), and a kiln (not depicted). In examples, the conveyor element 602 may include the same or similar components and may operate in the same or a similar manner as the conveyor element 102 described with respect to FIG. 1. Additionally, the hoppers 604(a)-(c) may include the same or similar components and may operate in the same or a similar manner as the hoppers 104(a)-(c) described with respect to FIG. 1. Additionally, the kiln may include the same or similar components and may operate in the same or a similar manner as the kiln 106 described with respect to FIG. 1.

The hoppers 604(a)-(c) may be filled with precursor material 606(a)-(c). In the example of FIG. 6, the first precursor material 606(a) dispensed from the first hopper 604(a) may differ from the second precursor material 606(b) dispensed from the second hopper 604(b), which may differ from the third precursor material 606(c) dispensed from the third hopper 604(c). The volume and/or amount of precursor material 606(a)-(c) may be controllably released from the hoppers 604(a)-(c) to control the number of layers of material entering the kiln and/or the thickness of a given layer of the material. In the example shown in FIG. 6, the thickness of the three layers is approximately the same such that, as the precursor materials 606(a)-(c) enter the kiln, a base layer from the first hopper 604(a), a middle layer from the second hopper 604(b), and a top layer from the third hopper 604(c) is provided. In this example, a produced silicate aggregate may include a three-layer product, with each layer having differing properties from the other layers, such as open versus closed cell, porosity, density, and/or chemical properties.

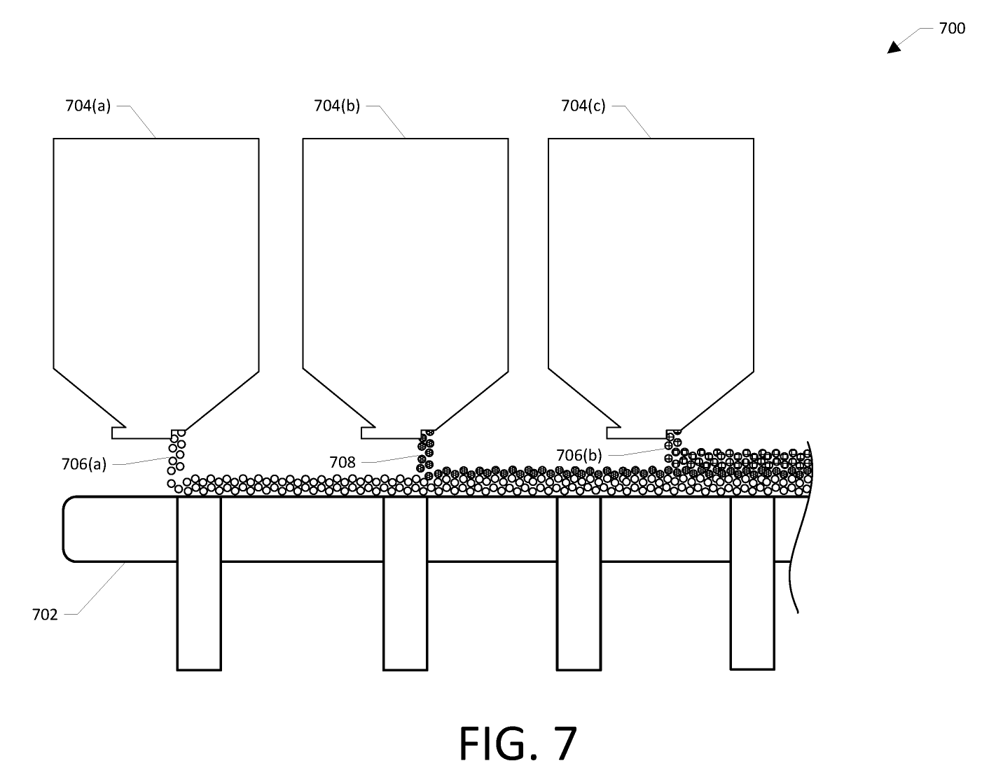

FIG. 7 illustrates a side view of a portion of another example system 700 for generating silicate aggregates showing three hoppers 704(a)-(c), with one of the hoppers 704(b) outputting a separation-layer material. The system 700 may include, for example, a conveyor element 702, two or more hoppers 704(a)-(c), and a kiln (not depicted). In examples, the conveyor element 702 may include the same or similar components and may operate in the same or a similar manner as the conveyor element 102 described with respect to FIG. 1. Additionally, the hoppers 704(a)-(c) may include the same or similar components and may operate in the same or a similar manner as the hoppers 104(a)-(c) described with respect to FIG. 1. Additionally, the kiln may include the same or similar components and may operate in the same or a similar manner as the kiln 106 described with respect to FIG. 1.

The first hopper 704(a) and the third hopper 704(c) may be filled with precursor material 706(a), 706(b). In the example of FIG. 7, the first precursor material 706(a) dispensed from the first hopper 704(a) may differ from the second precursor material 706(b) dispensed from the third hopper 704(c). Additionally, the second hopper 704(b) may be filled with a separation-layer material 708, such as crushed foam glass. The volume and/or amount of precursor material 706(a)-(b) may be controllably released from the hoppers 704(a), 704(c) to control the thickness of a given layer of the material. In the example shown in FIG. 7, the thickness of the two layers is approximately the same. However, unlike FIG. 6 where a produced silicate aggregate includes a three-layer product, two products may be produced from the use of the system 700 from FIG. 7. For example, while being heated in the kiln, the top layer and base layer of precursor materials 706(a), (b) may be converted to silicate aggregates, while the separation layer 708 may prohibit or decrease the binding of the top layer to the base layer. As such, the top layer may be separated from the base layer during or after manufacture of the silicate aggregates such that two products may be obtained during the same run time for the kiln.

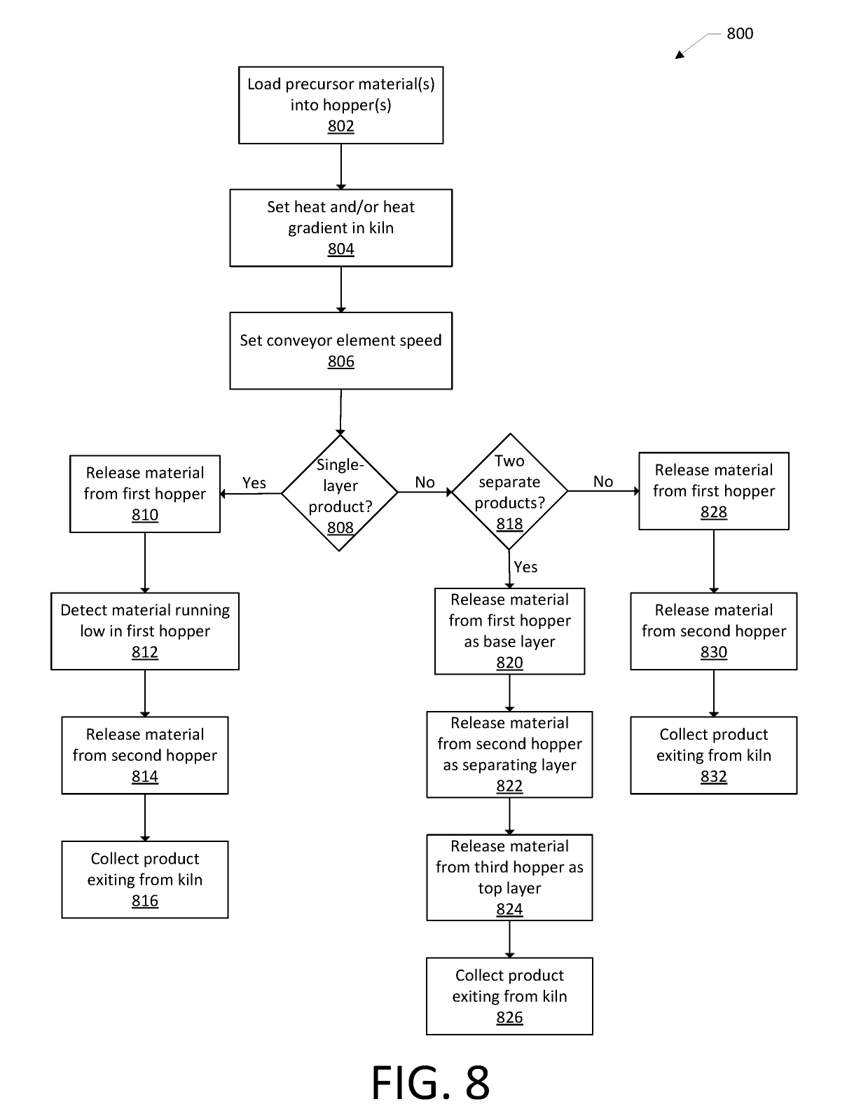

FIG. 8 illustrates processes for silicate aggregate manufacturing systems. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-7, although the processes may be implemented in a wide variety of other environments, architectures and systems.

FIG. 8 is a flowchart illustrating an example process 800 of manufacturing silicate aggregates utilizing the systems described herein. The order in which the operations or steps are described is not intended to be construed as a limitation, and any number of the described operations may be combined in any order and/or in parallel to implement process 800.

At block 802, the process 800 may include loading one or more precursor materials into two or more hoppers of a silicate aggregate manufacturing system. For example, the type and/or amount of precursor material, including, for example, silica compounds and/or one or more foaming agents, may be selected. A derrick or other mechanism may position the two or more hoppers, either sequentially or in parallel, at a location associated with filling operations. The selected precursor materials may be loaded into the hopper, and the derrick or other mechanism may reposition the hoppers above a conveyor element. The position of the hoppers relative to each other may be based on the type of product to be produced, but generally at least two hoppers may be positioned above the conveyor element. In examples where the hoppers are fixedly attached to a hopper-holding element, a filling tube or similar mechanism may be utilized to load the precursor materials into the hoppers.

At block 804, the process 800 may include setting a heat and/or heat gradient of a kiln associated with the silicate aggregate manufacturing system. In examples, the amount of heat applied by the kiln to the precursor materials may be adjustable. For example, the temperature inside the kiln may be between about 900° Fahrenheit and about 1,600° Fahrenheit. In further examples, the kiln may be configured to apply a heating gradient and/or differing temperatures to the precursor materials as they travel through the kiln. For example, a temperature of the kiln may be adjusted to be the highest about ⅓ of the way through the kiln such that the precursor materials may reach a working point and/or working temperature. Thereafter, the temperature may vary depending on, for example, the speed at which the conveyor element is moving and/or specifications for the silicate aggregate product desired as output from the kiln. In examples, the time between when the precursor materials enter the kiln and when a silicate aggregate product exits the kiln may be between about 40 minutes and about 75 minutes.

At block 806, the process 800 may include setting a speed of a conveyor element associated with the silicate aggregate manufacturing system. For example, the speed of movement of the conveyor element may be adjustable such that an amount of time from when the precursor material(s) enter the kiln and when the produced silicate aggregates exit the kiln may be varied. In examples, the amount of time may be between about 40 minutes and about 75 minutes. Additionally, the conveyor element may include a first section, a second section, and a third section. In examples, the first section may include at least the portion of the conveyor element that is positioned below the two or more hoppers. The second section may include at least the portion of the conveyor element that is associated with and/or is held within the kiln. The third section may include at least the portion of the conveyor element after the kiln and that carries, when in use, produced silicate aggregate from the kiln.

At block 808, the process 800 may include determining whether the silicate aggregate to be produced is a single-layer product. For example, when a single product is desired to be manufactured and that product is intended to include uniform physical and/or chemical characteristics, then it may be determined that the silicate aggregate to be produced is a single-layer product.

If the silicate aggregate to be produced is a single-layer product, the process 800 may continue to block 810, where the process 800 may include releasing precursor material from a first hopper of the hoppers. For example, two or more hoppers of a given system may be configured to release precursor materials sequentially. For example, the first hopper may release precursor materials and when the precursor materials in the first hopper have been exhausted or otherwise have been transferred to the conveyor element, a second hopper may initiate release of precursor materials. In this example, a continuous or near continuous flow of precursor materials may occur such that when one hopper empties or nearly empties another hopper initiates release of precursor materials.

At block 812, the process 800 may include detecting that an amount of the precursor material in the first hopper is running low and/or that the amount is below a threshold amount of precursor material. Detecting the amount of the precursor material may be performed by one or more processors executing instructions stored in association with computer-readable media. In these examples, one or more sensors may be utilized to detect when the amount of the precursor material is running low and/or is below the threshold amount of precursor material. The threshold amount of precursor material may be set, for example, based at least in part on the initial volume of materials added to the hopper, the rate at which the materials exit the hopper, and/or the speed of the conveyor element. In other examples, detecting the amount of the precursor material may be performed by a technician.

At block 814, the process 800 may include releasing the same or substantially the same precursor material from a second hopper of the hoppers. For example, the precursor material in the second hopper may be released at a time such that a continuous or near continuous layer of precursor material is deposited onto the conveyor element when the first hopper ceases depositing precursor material. While the second hopper releases precursor materials, the first hopper may be refilled such that when the second hopper empties, the first hopper may be caused to release precursor materials, and so on. By so doing, the conveyor may not require stoppage for refilling of precursor materials, the kiln may not require stoppage for refilling of precursor materials, and/or no or less interruption in the flow of precursor materials into the kiln may be achieved.

In other examples, instead of the hoppers being filled with the same precursor materials, two or more single-layer products may be consecutively produced by filling the first hopper with a first precursor material utilized to generate the first product and filling the second hopper with a second precursor material utilized to generate the second product.

At block 816, the process 800 may include collecting the silicate aggregate product exiting from the kiln. For example, the heat from the kiln may cause the precursor material to stratify, which may produce the silicate aggregate product. The silicate aggregate product may travel from the kiln to a collecting container and/or other vessel for storage and/or use. In examples, a compactor may be utilized to crush or otherwise fracture the silicate aggregate product.

Returning to block 808, if the silicate aggregate product to be produced is something other than a single-layer product, such as a multi-layer product and/or more than one product, then, at block 818, the process 800 may include determining whether more than one product is to be produced at the same time. For example, two products that may be kilned at the same time may be identified, and in these examples, it may be determined that more than one product is to be produced at the same time.

If more than one product is to be produced at the same time, then at block 820, the process 800 may include releasing precursor material from the first hopper of the hoppers as a base layer. Release of the precursor material may be performed in the same or a similar manner as described above with respect to block 810. This first precursor material may have a first composition and/or amount of given materials. In still other examples, one or more hoppers may be filled with precursor material as a backup supply to be utilized upon the occurrence of a condition, such as a shortage of working precursor material.

At block 822, the process 800 may include releasing a separation-layer material from the second hopper of the hoppers. The separation-layer material may be deposited on top of the base layer. For example, the separation-layer material may be crushed foamed glass.

At block 824, the process 800 may include releasing a different precursor material from a third hopper of the hoppers. The different precursor material may be deposited on top of the separation-layer material and may form a top layer. In these examples, the materials entering the kiln may correspond to a three-layer material. However, in other examples, multiple layers of multiple precursor materials may be deposited on the conveyor element, then a separation layer may be deposited, and then multiple layers of multiple precursor materials may be deposited on the separation layer. In these examples, multiple products having multiple layers may be manufactured at the same time. In other examples, more than one separation layer may be deposited such that at least three different products may be manufactured at the same time. As the materials work their way through the kiln, the separation layer(s) may prohibit and/or minimize the bonding of the materials on top of and below the separation layer(s).

At block 826, the process 800 may include collecting a first silicate aggregate product associated with the base layer and collecting a second silicate aggregate product associated with the top layer. For example, with the separation layer prohibiting and/or minimizing bonding between the other layers, the base-layer product may be collected and separated from the top-layer product.

Returning to block 818, if two separate products are not to be manufactured at the same time, then, at block 828, the process 800 may include releasing precursor material from the first hopper of the hoppers. The precursor material may be deposited as a base layer on the conveyor element. Release of the precursor material from the first hopper may be performed in the same or a similar manner as described above with respect to block 810.

At block 830, the process 800 may include releasing a second precursor material from the second hopper of the hoppers. The second precursor material may be deposited on top of the base layer and may form a second layer. It should be understood that additional hoppers depositing additional layers may be utilized. While the materials are heated by the kiln, the multiple layers of precursor material may at least partially bind together to form a silicate aggregate product having multiple layers.

At block 832, the process 800 may include collecting the silicate aggregate product having multiple layers exiting from the kiln. Collection of the product may be performed in the same or a similar manner as described with respect to block 816.

While various examples and embodiments are described individually herein, the examples and embodiments may be combined, rearranged and modified to arrive at other variations within the scope of this disclosure.

Although embodiments have been described in language specific to structural features and/or methodological acts, it is to be understood that the disclosure is not necessarily limited to the specific features or acts described. Rather, the specific features and acts are disclosed herein as illustrative forms of implementing the claimed subject matter. Each claim of this document constitutes a separate embodiment, and embodiments that combine different claims and/or different embodiments are within the scope of the disclosure and will be apparent to those of ordinary skill in the art after reviewing this disclosure.

What is claimed is:

1. A system comprising:
a conveyor element positioned substantially horizontally and configured to move precursor materials from a first portion of the conveyor element to a second portion of the conveyor element and to a third portion of the conveyor element;
a kiln positioned at the second portion of the conveyor element, the kiln having a channel configured to receive the second portion of the conveyor element, wherein a first end of the kiln is configured to receive the precursor materials via the conveyor element and a second end of the kiln, opposite the first end, is configured to output a product at the third portion of the conveyor element, the kiln further configured to apply heat to the precursor materials;
a first hopper positioned above the first portion of the conveyor element, the first hopper configured to hold a first precursor material of the precursor materials; and
a second hopper positioned above the first portion of the conveyor element, the second hopper configured to hold a second precursor material of the precursor materials, wherein the second hopper is situated between the first hopper and the kiln.

2. The system of claim 1, further comprising:
a first derrick coupled to the first hopper, the first derrick configured to move the first hopper from a first position above the first portion of the conveyor element to a second position associated with filling of the first hopper with the first precursor material; and
a second derrick coupled to the second hopper, the second derrick configured to move the second hopper from a third position above the first portion of the conveyor element to a fourth position associated with filling of the second hopper with the second precursor material.

3. The system of claim 1, further comprising a hopper receptacle having:
a first opening configured to at least partially receive the first hopper and maintain the first hopper above the first portion of the conveyor element; and
a second opening configured to at least partially receive the second hopper and maintain the second hopper above the first portion of the conveyor element.

4. The system of claim 1, further comprising a derrick associated with the first hopper and the second hopper, the derrick having a grasping element configured to releasably couple to the first hopper at a first time and to releasably couple to the second hopper at a second time, the derrick configured to move the first hopper from a first position above the first portion of the conveyor element to a second position associated with filling of the first hopper with the first precursor material, the derrick further configured to move the second hopper from a third position above the first portion of the conveyor element to the second position.

5. A system comprising:
a conveyor element configured to move material;
a kiln having a channel configured to receive a first portion of the conveyor element, the kiln further configured to apply heat to the material within the kiln;
a first hopper positioned above a second portion of the conveyor element; and
a second hopper positioned above the second portion of the conveyor element, the second hopper situated between the first hopper and the kiln.

6. The system of claim 5, further comprising:
a first derrick coupled to the first hopper, the first derrick configured to move the first hopper from a first position above the second portion of the conveyor element to a second position associated with filling of the first hopper with the material; and
a second derrick coupled to the second hopper, the second derrick configured to move the second hopper from a third position above the second portion of the conveyor element to a fourth position associated with filling of the second hopper with at least one of the material or another material.

7. The system of claim 5, further comprising a hopper receptacle having:
a first opening configured to at least partially receive the first hopper and maintain the first hopper above the second portion of the conveyor element; and
a second opening configured to at least partially receive the second hopper and maintain the second hopper above the second portion of the conveyor element.

8. The system of claim 5, further comprising a derrick having a grasping element configured to releasably couple to the first hopper at a first time and to releasably couple to the second hopper at a second time.

9. The system of claim 5, wherein at least one of the first hopper or the second hopper includes an adjustable nozzle configured to adjustably open and close such that a volume of the material traveling through the adjustable nozzle is increased when the adjustable nozzle is opened and is decreased when the adjustable nozzle is closed.

10. The system of claim 5, further comprising a third hopper positioned above the second portion of the conveyor element and between the second hopper and the kiln, wherein:
the first hopper is configured to receive a first material that forms a first layer after exiting the kiln;
the third hopper is configured to receive a second material that forms a second layer after exiting the kiln; and
the second hopper is configured to receive a third material that prevents bonding between the first layer and the second layer when heat is applied by the kiln.

11. The system of claim 5, further comprising:
one or more processors; and
non-transitory computer-readable media including instructions that, when executed by the one or more processors, cause the one or more processors to perform operations comprising:
causing a first shutter associated with the first hopper to open such that the material is permitted to travel from the first hopper to the conveyor element;
determining that an amount of the material in the first hopper is below a threshold amount of material; and
causing, based at least in part on determining that the amount of the material is below the threshold amount of the material, a second shutter associated with the second hopper to open such that the material is permitted to travel from the second hopper to the conveyor element.

12. The system of claim 5, wherein a first shutter associated with the first hopper is in an open position during operation of the conveyor element and a second shutter associated with the second hopper is in the open position during operation of the conveyor element such that a first material is permitted to travel from the first hopper to the conveyor element substantially contemporaneously with a second material travelling from the second hopper to the conveyor element, the first hopper configured to deposit the first material as a first layer and the second hopper configured to deposit the second material as a second layer above the first layer.

13. A device comprising:
a conveyor belt;
a kiln having a channel configured to receive a first portion of the conveyor belt;
a first hopper positioned above a second portion of the conveyor belt; and
a second hopper positioned above the second portion of the conveyor belt, the second hopper situated between the first hopper and the kiln.

14. The device of claim 13, further comprising:
a first derrick coupled to the first hopper, the first derrick configured to move the first hopper; and
a second derrick coupled to the second hopper, the second derrick configured to move the second hopper.

15. The device of claim 13, further comprising a hopper receptacle having:
a first opening configured to at least partially receive the first hopper and maintain the first hopper above the second portion of the conveyor belt; and
a second opening configured to at least partially receive the second hopper and maintain the second hopper above the second portion of the conveyor belt.

16. The device of claim 13, further comprising a derrick having a grasping element configured to grasp at least a portion of the first hopper at a first time and to grasp at least a portion of the second hopper at a second time.

17. The device of claim 13, wherein at least one of the first hopper or the second hopper includes an adjustable nozzle configured to adjustably open and close such that a volume of the material traveling through the adjustable nozzle is increased when the adjustable nozzle is opened and is decreased when the adjustable nozzle is closed.

18. The device of claim 13, further comprising a third hopper positioned above the second portion of the conveyor belt and between the second hopper and the kiln.

19. The device of claim 13, further comprising:
one or more processors; and
non-transitory computer-readable media including instructions that, when executed by the one or more processors, cause the one or more processors to perform operations comprising:
causing a first wheel associated with the first hopper to rotate such that the material is promoted to exit the first hopper;
determining that an amount of the material in the first hopper is below a threshold amount of material; and
causing, based at least in part on determining that the amount of the material is below the threshold amount of the material, a second wheel associated with the second hopper to rotate such that the material is promoted to exit the second hopper.

20. The device of claim 13, wherein a first shutter associated with the first hopper is in an open position during operation of the conveyor belt and a second shutter associated with the second hopper is in the open position during operation of the conveyor belt such that a first material is permitted to travel from the first hopper to the conveyor belt substantially contemporaneously with a second material exiting from the second hopper.
